(19) United States
(12) Patent Application Publication
(10) Pub. No.: US 2017/0127254 A1
(43) Pub. Date: May 4, 2017

(54) AUTOMATIC METHOD FOR KEEPING CALLS CONNECTED

(71) Applicant: Nagravision S.A., Cheseaux-sur-Lausanne (CH)

(72) Inventors: Charles M. Fish, Furlong, PA (US); Brad Mason, San Jose, CA (US)

(21) Appl. No.: 14/925,871

(22) Filed: Oct. 28, 2015

(51) Int. Cl. H04W 4/16; H04M 3/42

(52) U.S. Cl. CPC H04W 4/16; H04M 3/42195

(57) ABSTRACT

In example embodiments, a system and method for keeping calls connected are provided. A call is initiated between a first user device and a second user device each of which has a connection application for maintaining communications. A call maintenance option provided by the connection application is activated on the first and second user devices. A determination is made that one of the first user device or the second user device is a call manager, whereby the call manager is responsible for reinitiating the call in response to the call being dropped. Detection that the call is dropped is made. In response to the detection that the call is dropped, the call manager reinitiates the call while the non-call manager waits in a standby mode for the reinitiation of the call.

### FIELD

The present disclosure relates generally to communications, and in a specific example embodiment, to keeping calls connected.

### BACKGROUND

Dropped calls may occur frequently and cause frustration for users making the calls. A frequency of dropped calls may vary based on devices used (e.g., particular handsets or mobile devices) and network service providers. However, the problem of dropped calls is not a quality of service issue being addressed by handset makers or network service providers. Conventionally, when a call is dropped, both users (e.g., callers) try to call each other back, and, inadvertently, get each other's voicemail or a busy signal as a result. As a result, a game of “phone tag” is commenced between the two users. For secure telephone applications, this problem can be even more frustrating.

### BRIEF DESCRIPTION OF DRAWINGS

Various ones of the appended drawings merely illustrate example embodiments of the present invention and cannot be considered as limiting its scope.

FIG. 1 is a diagram illustrating an example environment in which embodiments of a system for keeping calls connected may be implemented.

FIG. 2 is a block diagram illustrating an example embodiment of a user device.

FIG. 3 is a block diagram illustrating an example embodiment of a service provider system.

FIG. 4 is an example communication flow diagram for keeping calls connected according to one embodiment.

FIG. 5 is a flow diagram of an example method for keeping calls connected at a network service provider.

FIG. 6 is a flow diagram of an example method for keeping calls connected at a user device.

FIG. 7 is a simplified block diagram of a machine in an example form of a computing system within which a set of instructions for causing the machine to perform any one or more of the methodologies discussed herein may be executed.

FIG. 8 is a block diagram illustrating a mobile device, according to an example embodiment.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Example embodiments described herein provide systems and methods for keeping calls (or other forms of communications) connected. A call is initiated between a first user device and a second user device, each of which has a connection application for maintaining communications. A call maintenance option provided by the connection application is activated on the first and second user device that keeps the call connected. A determination is made that one of the first user device or the second user device is a call manager, whereby the call manager is responsible for reinitiating the call in response to the call being dropped. The determination of which user device is the call manager is, in one embodiment, based on a negotiation process performed between the user devices of the call. As such, the user devices periodically exchange parameter data with each other. The parameter data is compared (and sometimes weighted or combined in various combinations) to determine which of the user devices has better parameters or particular combination of parameters. The user device with the better parameters is designated the call manager.

Detection that the call has been dropped is made. The detection may be based on whether the call ended without a call end signal. In response to the detection that the call is dropped, the call manager reinitiates the call while the non-call manager waits for the reinitiation of the call in a standby mode.

Accordingly, a connection application is provided on each user device of a first user and a second user. The connection application provides functionalities to keep calls connected by monitoring for dropped calls and automatically reinitiating a call, from one of the user devices, based on a detection of a dropped call. The user device that reinitiates the call is determined through a negotiation process performed by and between the user devices in a call in accordance with one embodiment. The negotiation process comprises an exchange of parameters between the user devices in the call whereby the user device that has a better combination of parameters will be designated a call manager and will reinitiate the call. The negotiation process occurs periodically such that the call manager may change one or more times during the course of a call. As a result, there is a dynamic, agreed call manager designation between the user devices.

As a result, one or more of the methodologies described herein facilitate call connections and maintenance of a call. When a call is dropped, the users will not each individually try to re-establish the call by initiating a call connection (e.g., redialing) to the other user, resulting in a busy signal or reaching the other user's voicemail. Furthermore, since only one user reinitiates the call connection in example embodiments, few communication lines are used, thus providing more bandwidth for other users of a network service provider to utilize services of the network service provider. When these effects are considered in aggregate, one or more of the methodologies described herein may obviate a need for certain efforts or resources that otherwise would be involved in establishing and maintaining call connections. Additionally, computing resources used by one or more machines, databases, or devices (e.g., within the network environment) may be reduced. Examples of such computing resources include processor cycles, network traffic, memory usage, data storage capacity, power consumption, network bandwidth, and cooling capacity.

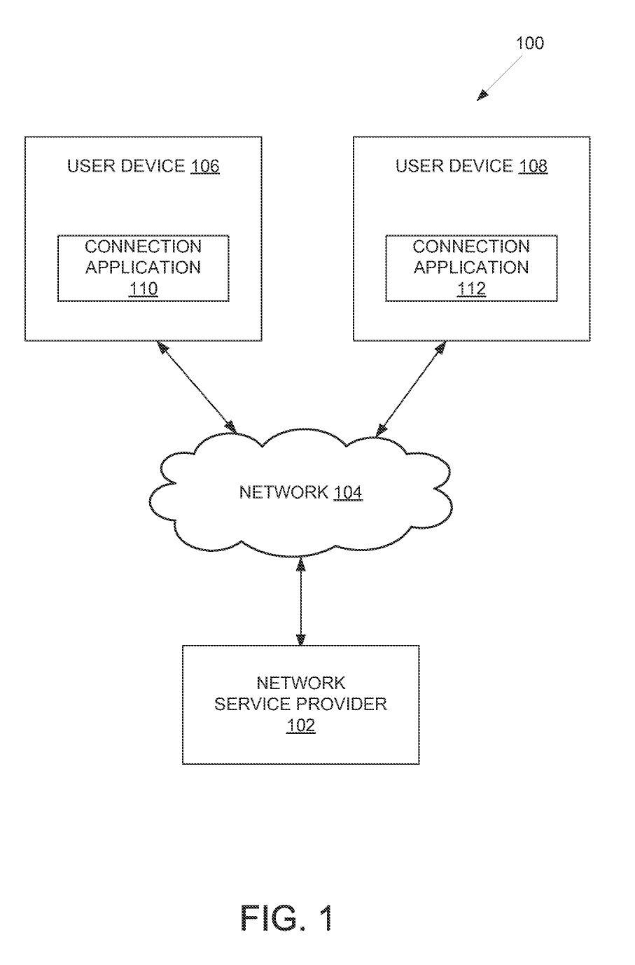

With reference to FIG. 1, a diagram illustrating an example environment 100 in which embodiments of a system for keeping calls connected is provided. The environment 100 comprises a network service provider 102 coupled via a network 104 (e.g., the Internet, wireless network, cellular network, PSTN, or a Wide Area Network (WAN)) to user devices (e.g., a first user device 106 and a second user device 108). The first user device 106 is associated with a first user that initiates a call. In example embodiments, the first user has downloaded or otherwise installed a connection application 110 onto their user device 106. When activated, the connection application 110 configures the first user device 106 to detect a dropped call, exchange parameters, and, in some instances, reinitiate a call based on a call being dropped and based on the first user device 106 being designated the call manager. The user device 106 may comprise a mobile phone, smartphone, laptop, tablet, or any other communication device that a user may utilize to store, access, or operate the connection application 110. In one embodiment, the user device 106 may comprise a gateway device coupled to a call initiating device (e.g., a telephone, VoIP phone) that may call a mobile device.

The second user device 108 is associated with a second user that is a call recipient of a call initiated by the first user. Similar to the first user device 106, the second user device 108 comprises a connection application 112 that has been downloaded or otherwise installed thereon. When activated, the connection application 112 configures the second user device 108 to detect a dropped call, exchange parameters, and, in some instances, reinitiate a call based on a call being dropped and based on the second user device 108 being designated the call manager. The user device 108 may comprise a mobile phone, smartphone, laptop, tablet, gateway device, or any other communication device that a user may utilize to store, access, or operate the connection application 112.

The connection applications 110 and 112 configure the user devices 106 and 108 to provide functions or operations that enable the user devices 106 and 108 to detect dropped calls, monitor and exchange parameters, determine which user device 106 or 108 will reinitiate a call that has been dropped, and reinitiate the call accordingly, as will be discussed in more detail below. In some embodiments, the network service provider 102 provides the connection applications 110 and 112 to the respective user devices 106 and 108 (e.g., provide a down loadable version of the connection application, electronically send the connection application to the user device 106, installs the connection application on the user device 106 prior to shipment to the user, or physically send to the user via a storage medium such as a CD ROM).

It is noted that the environment 100 shown in FIG. 1 is merely an example. For example, alternative embodiments may comprise any number of user devices 106 and 108 in the environment 100 and any number of network service providers 102. Additionally, a call may be conducted between more than two user devices.

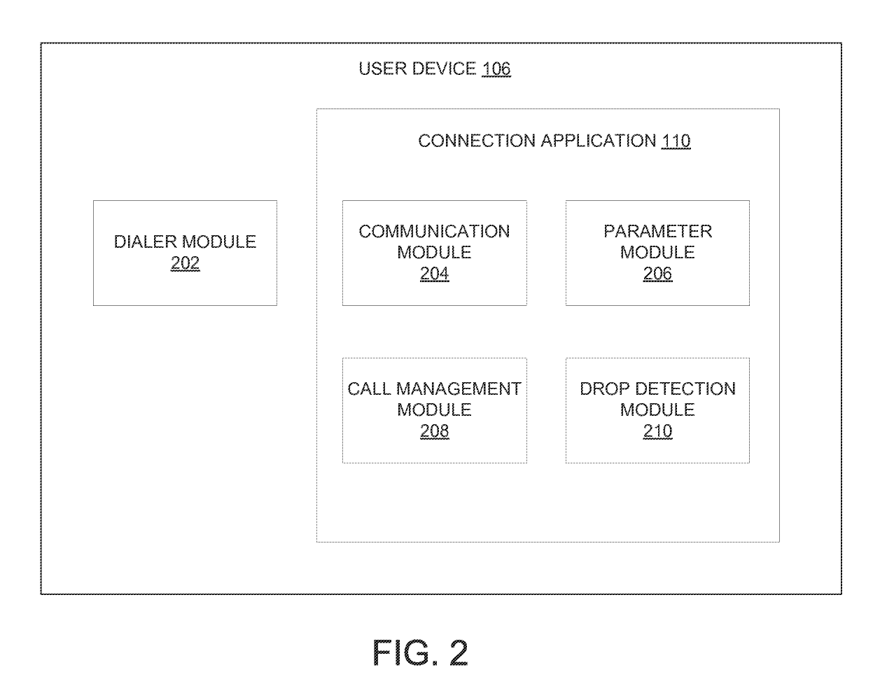

Referring now to FIG. 2, a block diagram illustrating an example embodiment of the (first) user device 106 of the first user is shown. It is noted that the second user device 108 may comprise similar components. The user device 106 comprises a dialer module 202 and the connection application 110. In some embodiments the dialer module 202 may be a part of the connection application 110. The dialer module 202 manages initiation of communications for the user device 106. Upon activation of the dialer module 202, the user of the user device 106 can dial a number of a callee (e.g., the second user) or select a number for the callee from stored contact information (e.g., from an address book and contact list). Once the number is entered and a call initiated (e.g., selecting a “dial” or “talk” button), the dialer module 202 sends a request to the network service provider 102 requesting a call connection with the callee associated with the dialed number (e.g., the user at the second user device 108).

The connection application 110 provides call connection maintenance functionalities and services to the user device 106 to keep a call connected (e.g., reestablish a call when the call is dropped). In example embodiments, the connection application 110 provides an indication (e.g., display on a user interface of the user device 106) that a call initiated with a call maintenance option selected (e.g., activation of a “keep connected” option of the connection application 110) is a “keep connected” call. In various embodiments, the connection application 110 comprises a communication module 204, a parameter module 206, a call management module 208, and a drop detection module 210. It is noted that the user device 106 and the connection application 110 may comprise other modules not pertinent to example embodiments and are thus not shown or discussed. In various embodiments, the connection application 112 on the second user device 108 comprises a similar connection application.

The communication module 204 manages exchange of data within the connection application 110 and between the connection application 110 and other devices in the environment 100. For example, the communication module 204 transmits and receives parameter data with the other devices and receives (or transmits) dropped call notifications. Accordingly, the communication module 204 comprises or is coupled to a receiver device and a transmitter device (e.g., antenna).

The parameter module 206 periodically or continuously detects parameters of the first user device 106 and maintains (or obtains) parameter data for both the first user device 106 and the second user device 108. As such, the parameter module 206 may comprise or be coupled to one or more sensors in the user device 106 that detect, for example, signal strength, number of available towers, likelihood of a call being dropped, and network speed for the first user device 106 at selected or pseudo-random time intervals during the call (e.g., every two minutes) or based on certain events (e.g., when one of the user devices switches to a different tower or a single parameter changes by more than a preset amount (e.g., signal strength drops by a certain percentage for a certain period of time)). In one embodiment, if the user device is connected (or connectable) to an LTE network, it is advantageous to consider signal strength as a percent range, for example mapping 1 ASU=0% (≈−135 dBm); 70 ASU=100% (≈−70 dBm); and other or intermediate values accordingly (e.g., in buckets, such as 10-15 ASU≈very good signal strength) for calculation and comparison. Other parameters of the user device 106 may also be monitored or detected by the parameter module 206.

Device usage patterns (whether chosen by the user, for example, use of “missed call” messaging or the like) may be detected and assigned parameters, in one embodiment. Other preferences or settings chosen by a device user may also, preferably, be considered or monitored. For example, a user might indicate a disinclination for roaming or a certain network technology (e.g., 3G) or for especially frequent call drops (e.g., >4 per hour) by choosing certain preferences or settings on the user device. Those preferences associated with that user device may be included, weighted, or compared in applying rules to determine scores, in various embodiments.

Additionally, the parameter module 206 periodically exchanges parameters with the other call-connected user device (e.g., the second user device 108), as part of a call manager negotiation process, at predetermined time intervals during the call (e.g., every two minutes) or based on certain events (e.g., when one of the user devices switches to a different tower, when a parameter changes). For example, the parameter module 206 of the first user device 106 receives parameter data for the second user device 108 when a parameter at the second user device 108 changes. Accordingly, the communication module 204 receives the parameter data from the second user device 108 (e.g., directly from the second user device 108 or via the network service provider 102) and provides the parameter data to the parameter module 206 at the user device 106. The parameter module 206 also provides parameter data detected for the first user device 106 to the second user device 108 (e.g., directly to the second user device 108 or through the network service provider 102).

The call management module 208 manages call reinitiating operations for the user device 106. In example embodiments, the call management module 208 determines which user device (e.g., the first user device 106 or the second user device 108) is the call manager and should reinitiate a call when a call is dropped. The call management module 208 makes this determination based on a negotiation process involving the parameters that are exchanged with the other devices in the environment 100. In example embodiments, the user device (e.g., either the (first) user device 106 or the (second) user device 108) that has better parameters (e.g., a higher parameter score or weighted manager rating) is designated a “call manager” and will reinitiate the call. For example, if one of the user devices 106 or 108 has a higher signal strength or has more cellular towers available, that user device 106 or 108 could be selected as the call manager. Again, user selected settings or preferences may also, in some embodiments, be factored in to the automated determination.

As such, the call management module 208 should perform a comparison of selected parameter data for the user device 106 and the second user device 108 to determine which user device has better parameters or higher parameter score/weighted manager ratings. Relevant parameters could include availability of a signal booster system to a user device, current, medium, or average signal strength (RSSI, RSRP, RSCP, ASU, or the like), number of available towers in the same network, number of adjacent (roaming or not) towers or networks, device type, and country code, number of similar (e.g., 3G or LTE) calls dropped in last x number of hours of use, likelihood of a call being dropped, speed (e.g., velocity) of the user device (e.g., is it moving and how quickly), signal quality (or some measure of signal to noise ratio), local weather (e.g., sourced, for example, from a weather app on the user device), adjacency to network (or country) boundaries, and network speed. Any combination of one or more of the parameters may be used in determining which user device has the better parameters. Additionally, in some embodiments, the parameters may be weighted to create a weighted manager rating or parameter score. For example, in a given environment or situation, signal strength may be more important that likelihood of a call being dropped (e.g., based on a history of calls being dropped by that particular user device). Therefore, signal strength may be weighted more heavily than a probability-based parameter indicating a measure of the call drop likelihood by one or another user device.

By way of example, an automated rule or algorithm may be implemented such that

MRₚ=5(SS)−2(1/P_{d})+Nₜ−3(R)

where MRₚ=manager rating based on parameters, SS=signal strength (expressed as % from ASU), P_{d}=probability of drop based on last 2 hours of usage, Nₜ=number of cell towers at current time, t, and R=number of roaming calls in last 2 hours. Note that the coefficients shown here may be periodically altered, for example, if usage in a particular cell or group of cells indicates a different value.

As such, the call management module 208 of the first user device 106 and a similar call management module in the second user device 108 negotiates and agrees upon which of the two user devices 106 or 108 will be the call manager. The call manager will be the user device to reinitiate the call if the call is dropped. In example embodiments, the negotiation as to which user device will be the call manager is performed periodically. For example, the negotiation may occur each time a parameter changes at one of the connected user devices 106 and 108, during an event occurrence (e.g., change of cellular tower by the user device 106), or at a predetermined time (e.g., every five minutes). In accordance with an embodiment discussed below, the results may be shared with the network.

The drop detection module 210 identifies when a call is dropped. Accordingly, the drop detection module 210 may comprise or be coupled to a sensor that receives an “end of call” signal. For example, if the user of the user device 106 selects an “end” button on the user device 106 to end a call, the “end of call” signal (e.g., the selection of the “end” button or an “on hook” signal) is detected by the sensor associated with the drop detection module 210. Alternatively, if the user at the second user device 108 selects an “end” button on the second user device 108 to end the call, an “end of call” signal is transmitted from the second user device 108 to the user device 106 (e.g., directly or via the network service provider 102). The “end of call” signal is received by the communication module 204 from the second user device 108 and provided to the drop detection module 210. If no “end of call” signal is detected by the drop detection module 210 and the call has ended, then the drop detection module 210 identifies the call as being dropped. In one embodiment, the detection of the dropped call by the user device 106 is reported to the network service provider 102 (e.g., via a notification transmitted by the communication module 204), and the network service provider 102 may notify the second user device 108 regarding the dropped call. Conversely, the second user device 108 may detect the dropped call and notify the network service provider 102, which then notifies the user device 106. In an alternative embodiment, the network service provider 102 may determine that the call has been dropped and send a notification to each of the user devices 106 and 108 involved in the dropped call.

Accordingly, if the drop detection module 210 determines that a call has been dropped, the drop detection module 210 triggers (e.g., provides instructions to) the call management module 208 to determine whether the user device 106 is the client manager and should reinitiate the call. If the first user device 106 is determined to be the call manager and should reinitiate the call, the call management module 208 triggers (e.g., sends instructions to) the dialer module 202 to reinitiate the call (e.g., dial the number for the second user device 108). If the second user device 108 should reinitiate the call (e.g., the first user device 106 is not the call manager), then the first user device 106 will remain in a standby mode for a predetermined period of time to receive the call to be reinitiated by the second user device 108.

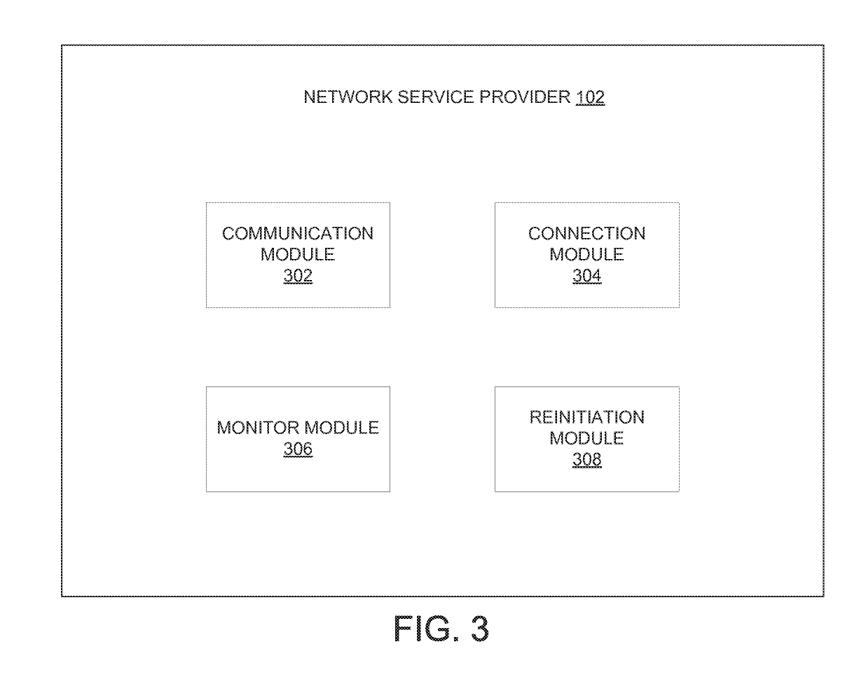

Referring now to FIG. 3, the network service provider 102 is shown in more detail. In example embodiments, the network service provider 102 comprises one or more servers that provide functionalities and services to the user devices 106 and 108 to keep a call connected between the user devices 106 and 108 (e.g., reestablish a call when the call is dropped). To enable these functionalities and services, the network service provider 102 comprises a communication module 302, a connection module 304, a monitor module 306, and a reinitiation module 308 coupled in communication with each other. The network service provider 102 may comprise other components not pertinent to example embodiments that are not shown or discussed. Furthermore, alternative embodiments may comprise more, less, multiples of, or other modules for providing international dialing through call connections. Additionally, some functions of the modules may be combined or divided into two or more further modules.

The communication module 302 manages exchange of data between the first and second user devices 106 and 108. Accordingly, the communication module 302 receives parameter data from each of the first and second user devices 106 and 108, and transmits the parameter data to the other user device. In some embodiments, the network service provider 102 may store or cache the parameter data. The communication module 302 also receives and transmits dropped call notifications.

Further still, the communication module 302 receives an indication to initiate or reinitiate a call from one of the first or second user device 106 or 108. In response to receiving the indication to initiate or reinitiate the call, the communication module 302 triggers or notifies the connection module 304 to establish (or re-establish) the call. In response, the connection module 304 establishes or reestablishes a call between the first and second user device 106 and 108. Accordingly, the connection module 304 comprises or is coupled to switches or other hardware devices that establish a communication exchange between the first and second user device 106 and 108.

In some embodiments, the monitor module 306 monitors for dropped calls instead of, or in addition to, the detection of dropped calls performed at the user devices 106 and 108. Accordingly, the monitor module 306 may comprise or be coupled to a sensor that detects an “end of call” signal. For example, if the user of the first user device 106 selects an “end” button on the first user device 106 to end a call, the “end of call” signal (e.g., the selection of the “end” button or an “on hook” signal) is transmitted to the network service provider 102 and detected by the sensor associated with the monitor module 306. If no end of call signal is detected by the monitor module 306, then the monitor module 306 determines that the call is dropped. In an alternative embodiment, one or both of the user devices (e.g., user device 106 or 108) detects the dropped call and notifies the network service provider 102 (e.g., via a notification received by the communication module 302). For example, the second user device 108 may detect the dropped call and notify the network service provider 102, which then notifies the first user device 106.

Further still, the monitor module 306 can detect the dropped call and report the dropped call to one or both of the user devices 106 and 108 involved in the dropped call. For example, the network service provider 102 can detect a dropped call when a particular cellular tower is experiencing a service outage or if a system failure occurs at the network service provider 102.

The reinitiation module 308 determines, at the network service provider 102, which user device (e.g., the first user device 106 or the second user device 108) is the call manager and should reinitiate a call when a call is dropped. The reinitiation module 308 makes this determination based on the parameters (discussed above) that are received from the user devices during the course of a call connected by the connection module 304. The network service provider may also, in one embodiment, automatically review and optimize rankings or weightings of different received parameters on a system-wide, group of cells, or a cell-by-bell basis. In these instances, the network service provider would publish revised rankings, weightings, coefficients, or rules to the user device applications as overhead data. As previously discussed, the first user device 106 and the second user device 108 periodically exchange parameter data during the call. In embodiments where the parameter data is exchanged via (e.g., the communication module 302) the network service provider 102, the reinitiation module 308 can determine (in addition to or in lieu of a similar determination performed by the user devices 106 and 108) which of the two user devices 106 or 108 should reinitiate the call when the call is dropped. Similar to the operations of the call management module 208, the reinitiation module 308 makes the determination based on which user device 106 or 108 has better parameters or parameter scores (e.g., signal strength, number of available towers, likelihood of a call being dropped, and network speed), better weighted parameters (e.g., higher weighted manager rating or weighted parameter score), better combination of parameters, better combination of weighted parameters, or any combination of these. Any combination of one or more of the parameters (including user defined preferences or settings) may be used in determining which user device 106 or 108 has the better parameters. The reinitiation module 308 then notifies the user devices 106 and 108 as to which one of the user devices 106 or 108 is the call manager. In embodiments where the user devices 106 and 108 perform the determination using the call management module 208, the reinitiation module 308 is optional or not needed in the network service provider 102.

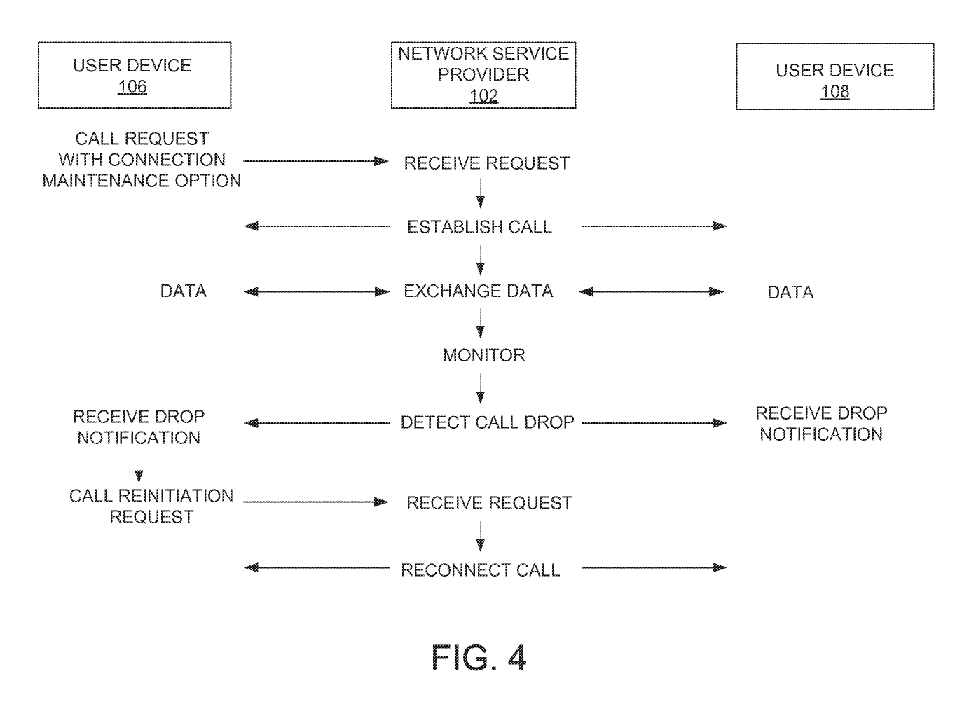

FIG. 4 is an example communication flow diagram for keeping a call connected according to one embodiment. The embodiment of FIG. 4 assumes that the first user device 106 initiates a call to a second user device 108 and has activated the “keep connected” option (e.g., call maintenance option). Accordingly, a user at the first user device 106 (referred to as “first user”) initiates a call to a user at the second user device 108 (referred to as “second user”). For example, the first user may dial a number for the second user or select the second user from a contact list. A call request is then received by the network service provider 102. The call request may be sent, for example by the dialer module 202 in conjunction with the connection application 110 and include a selection to utilize a call maintenance option. Activation of the call maintenance option (e.g., activation of a ‘keep connected” option of the connection application 110) enables operations to keep the call connected by the connection application 110 or the network service provider 102. In response to the call request, the network service provider 102 establishes the call between the first user device 106 and the second user device 108. The second user device 108 may also be notified that the call is a “keep connected” call and activate the call maintenance option at the connection application 112 of the second user device 108.

During the course of the call, parameter data is periodically exchanged between the first user device 106, the second user device 108, and/or the network service provider 102. In embodiments where the parameter data is exchange between the connected user devices 106 and 108 through the network service provider 102, the network service provider 102 periodically receives parameter data from each of the connected user devices 106 and 108 and forwards the received parameter data to the other connected user device. The network service provider 102 may also preferably maintain a record of the parameter data (e.g., in storage or cache) in embodiments where the network service provider 102 determines a call manager. Based on these record(s) of parameter data, the network service provider may optimize weightings, coefficients, or rules (e.g., based on how well the call maintenance system described herein functions over a period of time, and provide or publish such optimizations or changes to user devices as data for the application residing on the user device. In some embodiments, the first and second user devices 106 and 108 may exchange parameter data directly with the other connected user device.

During the call, the network service provider 102 monitors for a dropped call. In one embodiment, the network service provider 102 may detect that a call is dropped when an end of call signal is not detected by the network service provider 102. In an alternative embodiment, the network service provider 110 detects that a call is dropped when a notification of a dropped call is received from one or both of the user devices 106 or 108. The notification is generated by the user device 106 or 108 when the user device 106 and 108, itself, detects the dropped call.

Once detection of a dropped call occurs, the network service provider 102 may notify one or both of the user devices 106 or 108. For example, in embodiments where a dropped call determination is performed by the network service provider 102, the network service provider 102 sends the notification to both of the connected user devices 106 and 108. Alternatively, if, for example, the first user device 106 detects that a call is dropped but the second user device 108 has not detected the dropped call, a notification received from the first user device 106 is received by the network service provider 102 and transmitted to the second user device 108. In a further embodiment, the first and second user devices 106 and 108 can each determine whether a call is dropped and the network service provider 102 does not need to perform any call drop determination or notification.

Any one of the user devices 106 or 108 (e.g. call management module 208) or the network service provider 102 (e.g., reinitiation module 308) can determine which user device is the call manager and should reinitiate a call after the call is dropped. The determination is based on the parameter data received or exchanged between the first and second user device 106 and 108 as part of a negotiation process performed between the first and second user device 106 and 108 to identify one of the user devices 106 or 108 as the call manager. As a result, the call manager (e.g., the first user device 106) sends a call reinitiation request to the network service provider 102, while the non-call manager (e.g., the second user device 108) remains in a standby mode (e.g., for a predetermined period of time) to await the reinitiated call. In response to the call reinitiation request, the network service provider 102 reestablishes the call between the first and second user device 106 and 108.

While various embodiments and scenarios have been described in FIG. 4, these embodiments and scenarios are merely examples and embodiments of the present invention are not limited to just these. For example, the various operations of the example embodiments may be practiced in a different order or by different devices in the environment 100.

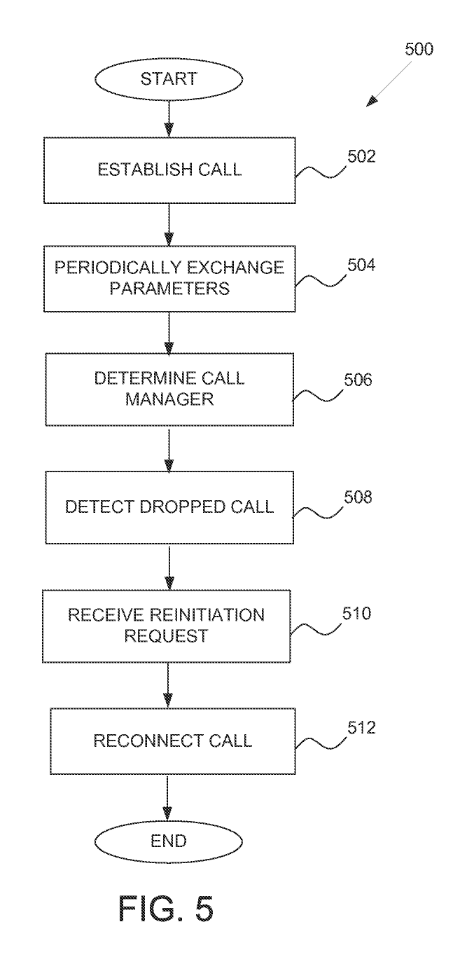

FIG. 5 is a flow diagram of an example method 500 for keeping calls connected. The operations of the method 500 occur at the network service provider 102. Accordingly, a user at the first user device 106 initiates a call to a second user at the second user device 108 by transmitting a call request to the network serviced provider 102. The call request is received by the communication module 302 of the network service provider 102. The call is established between the first user device 106 and the second user device 108 in operation 502.

In operation 504, parameter data for the two connected user devices 106 and 108 are periodically exchanged, via the network service provider 102, as part of a call manager negotiation process. The parameter data may be exchanged during periodical time intervals during the call (e.g., every two minutes) or based on certain events (e.g., when one of the user devices switches to a different tower or a change in a parameter occurs). Accordingly, parameter data for the first user device 106 is received by the communication module 302. The parameter data is then transmitted to the second user device 108. Similarly, parameter data for the second user device 108 is received by the communication module 302 and transmitted to the first user device 106. The network service provider 102 may also maintain a record (e.g., in a storage device) of the parameter data. While example embodiments discuss the receipt of the parameter data from the connected user devices 106 and 108, in some embodiments, the network service provider 102 may comprise a component (e.g., the monitor module 306) comprising or coupled to sensors that can detect or obtain the parameters for the connected user devices 106 and 108.

In operation 506, a determination of a call manager is made by the network service provider 102. In example embodiments, the reinitiation module 308 determines, at the network service provider 102, which user device (e.g., the first user device 106 or the second user device 108) is the call manager and should reinitiate a call when a call is dropped. The reinitiation module 308 makes this determination based on the parameters that are received from the user devices 106 and 108 during the course of a call connected by the connection module 304. If the network service provider 102 performs the determination of the call manager, the network service provider 102 will notify the user devices 106 and 108 which one is the call manager and which one should enter a standby mode during a dropped call. In embodiments where the user devices 106 and 108 perform the determination using the call management module 208 of the connection application 110, operation 506 is optional.

In example embodiments, the determination of the call manager is periodically re-performed. For example, each time a parameter of one of the user devices changes or at a predetermined time interval, the reinitiation module 308 may reanalyze the parameters to determine which of the two connected user devices should be the call manager. As a result, the first user device 106 may initially be the call manager, but later the second user device 108 becomes the call manager because it has acquired better parameters than the first user device 106.

In operation 508, a dropped call is detected at the network service provider 102. In one embodiment, the network service provider 102 receives a notification from one or both of the user devices 106 or 108 that the call has been dropped. In an alternative embodiment, the network service provider 102 (e.g., the monitor module 306) directly detects that the call has been dropped. For example, the monitor module 306 (e.g., a sensor of the monitor module 306) can monitor for dropped calls instead of, or in addition to, the detection of dropped calls performed at the user devices 106 and 108.

In operation 510, a reinitiation request is received from the call manager (e.g., one of the first or second user devices 106 or 108). In response to the reinitiation request, the connection module 304 reconnects the call between the first and second user devices 106 and 108 in operation 512.

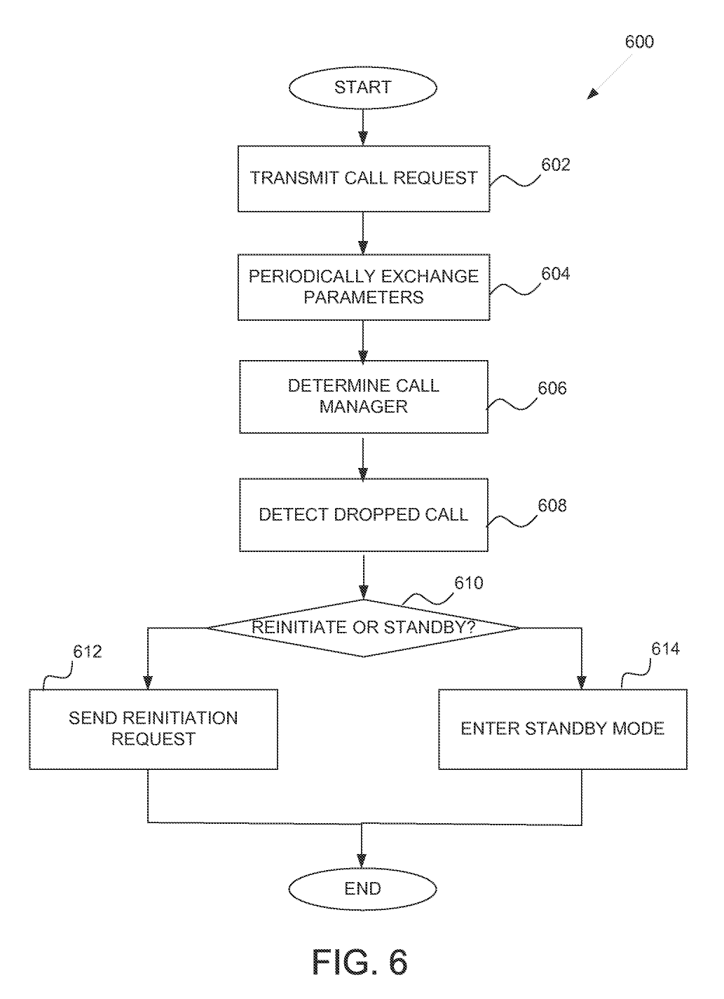

FIG. 6 is a flow diagram of an example method 600 for keeping calls connected at a user device (e.g., first user device 106). The operations of the method 600 are performed by the connection application 110 of the user device. In operation 602, the user at the user device 106 binitiates a call to a user at a second user device (e.g., the second user device 108). Accordingly a call request is transmitted by the dialer module 202 or the communication module 204 to the network service provider 102. In example embodiments, the call request includes a selection to utilize a call maintenance option. The call maintenance option enables operations to keep the call connected by the connection application 110 or the network service provider 102. If the call maintenance option is not selected, then a dropped call will not result in the automatic reconnection of the call by one of the user devices.

In operation 604, parameter data or parameter scores (e.g., as discussed above and including signal strength, number of available towers, likelihood of a call being dropped, speed of movement of a handset/user device, or network speed) is periodically exchanged between the connected user devices 106 and 108 as part of a call manager negotiation process. In example embodiments, the parameter module 206 periodically or continuously detects parameters of the first user device 106 and maintains (or obtains) parameter data for both the first user device 106 and the second user device 108. Additionally, the parameter module 206 periodically exchanges parameters with the other call-connected user device (e.g., the second user device 108). For example, the parameter module 206 of the first user device 106 receives parameter data for the second user device 108. As such, the communication module 204 receives the parameter data from the second user device 108 (e.g., directly from the second user device 108 or via the network service provider 102) and provides this parameter data to the parameter module 206 at the user device 106. The parameter module 206 also sends parameter data detected for the user device 106 to the second user device 108 (e.g., directly to the second user device 108 or through the network service provider 102).

In operation 606, a call manager is determined by the call management module 208. In example embodiments, the call management module 208 determines which user device (e.g., the (first) user device 106 or the second user device 108) is the call manager based on the parameters that are exchanged with the other devices in the environment 100. In example embodiments, the user device (e.g., either the (first) user device 106 or the second user device 108) that has better parameters is designated the call manager and will reinitiate the call. As such, the call management module 208 performs a comparison of the parameter data for the user device 106 and the second user device 108 to determine which user device has better parameters or combination of parameter (e.g., signal strength, number of available towers, likelihood of a call being dropped, and network speed).

In one embodiment, the call management module 208 of the first user device 106 and a similar call management module in the second user device 108 negotiates and agrees upon which of the two user devices 106 or 108 will be the call manager. In example embodiments, the negotiation as to which user device will be the call manager is performed periodically. For example, the negotiation may occur each time parameter data is exchanged between the two connected user devices 106 and 108, during an event occurrence (e.g., change of cellular tower by the user device 106), or at a predetermined time (e.g., every five minutes).

In example embodiments, the determination of the call manager is periodically re-performed. For example, each time parameters are updated or at a predetermined time interval, the call management module 208 may reanalyze the parameters to determine which of the two connected devices should be the call manager. As a result, the first user device 106 may initially be the call manager, but later the second user device 108 becomes the call manager because it subsequently acquired better parameters than the first user device 106.

In operation 608, a dropped call is detected by drop detection module 210. Accordingly, the drop detection module 210 may comprise or be coupled to a sensor that receives or detects an “end of call” signal. For example, if the user of the user device 106 selects an “end” button on the user device 106 to end a call, the “end of call” signal (e.g., the selection of the “end” button or an “on hook” signal) is detected by the sensor associated with the drop detection module 210. If no “end of call” signal is detected by the drop detection module 208 and the call has ended, then the drop detection module 210 identifies the call as being dropped. In one embodiment, the detection of the dropped call by the user device 106 is reported to the network service provider 102 (e.g., via a notification sent by the communication module 204), and the network service provider 102 may notify the second user device 108 regarding the dropped call. Conversely, the second user device 108 may detect the dropped call and notify the network service provider 102, which then notifies the user device 106. In an alternative embodiment, the network service provider 102 may determine that the call has been dropped and send a notification to each of the user devices involved in the dropped call.

In operation 610, the user device determines whether to reinitiate the call that has been dropped or to enter a standby mode and await the reinitiation of the call by the other user device. As a result, if the first user device 106 is the call manager, then the first user device 106 sends a reinitiation request in operation 612 to the network service provider 102. Alternatively, if the first user device 106 is not the call manager, then the first user device 106 enters a standby mode in operation 614 and waits for the call to be reinitiated by the second user device 108.

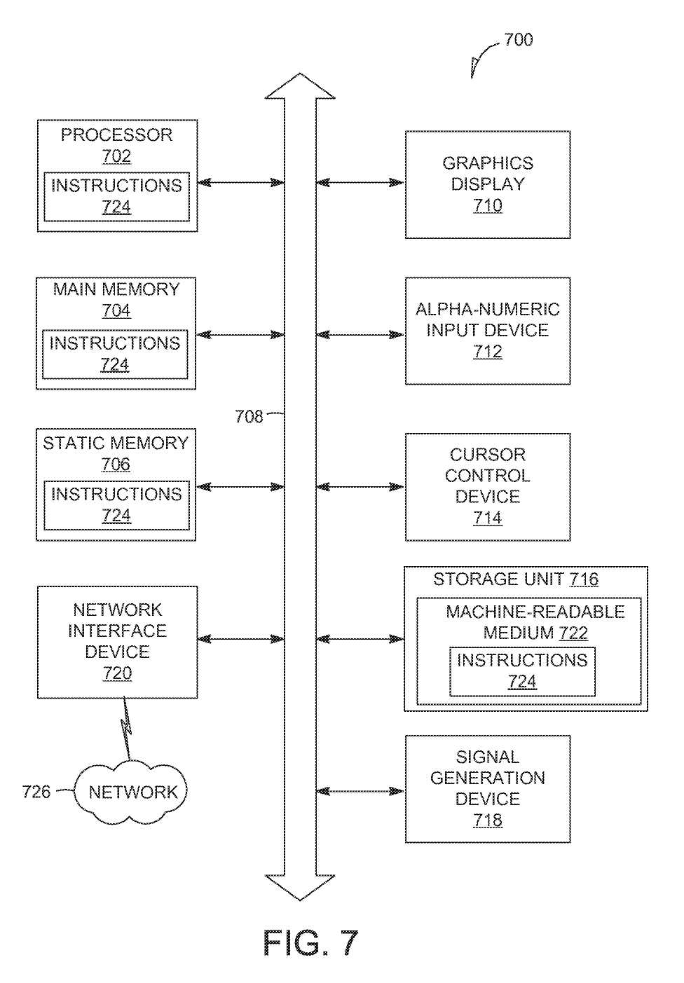

FIG. 7 is a block diagram illustrating components of a machine 700, according to some example embodiments, able to read instructions 724 from a machine-readable medium 722 (e.g., a non-transitory machine-readable medium, a machine-readable storage medium, a computer-readable storage medium, or any suitable combination thereof) and perform any one or more of the methodologies discussed herein, in whole or in part. Specifically, FIG. 7 shows the machine 700 in the example form of a computer system (e.g., a computer) within which the instructions 724 (e.g., software, a program, an application, an applet, an app, or other executable code) for causing the machine 700 to perform any one or more of the methodologies discussed herein may be executed, in whole or in part.

In alternative embodiments, the machine 700 operates as a standalone device or may be connected (e.g., networked) to other machines. In a networked deployment, the machine 700 may operate in the capacity of a server machine or a client machine in a server-client network environment, or as a peer machine in a peer-to-peer (or distributed) network environment. The machine 700 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 724, sequentially or otherwise, that specify actions to be taken by that machine. Further, while only a single machine is illustrated, the term “machine” shall also be taken to include a collection of machines that individually or jointly execute the instructions 724 to perform any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The processor 702 may contain microcircuits that are configurable, temporarily or permanently, by some or all of the instructions 724 such that the processor 702 is configurable to perform any one or more of the methodologies described herein, in whole or in part. For example, a set of one or more microcircuits of the processor 702 may be configurable to execute one or more modules (e.g., software modules) described herein.

The machine 700 may further include a graphics display 710 (e.g., a plasma display panel (PDP), a light emitting diode (LED) display, a liquid crystal display (LCD), a projector, a cathode ray tube (CRT), or any other display capable of displaying graphics or video). The machine 700 may also include an alphanumeric input device 712 (e.g., a keyboard or keypad), a cursor control device 714 (e.g., a mouse, a touchpad, a trackball, a joystick, a motion sensor, an eye tracking device, or other pointing instrument), a storage unit 716, a signal generation device 718 (e.g., a sound card, an amplifier, a speaker, a headphone jack, or any suitable combination thereof), and a network interface device 720.

The storage unit 716 includes the machine-readable medium 722 (e.g., a tangible and non-transitory machine-readable storage medium) on which are stored the instructions 724 embodying any one or more of the methodologies or functions described herein. The instructions 724 may also reside, completely or at least partially, within the main memory 704, within the processor 702 (e.g., within the processor's cache memory), or both, before or during execution thereof by the machine 700. Accordingly, the main memory 704 and the processor 702 may be considered machine-readable media 722 (e.g., tangible and non-transitory machine-readable media).

In some example embodiments, the machine 700 may be a portable computing device, such as a smart phone or tablet computer, and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 722 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 700), such that the instructions, when executed by one or more processors of the machine (e.g., processor 702), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Furthermore, the tangible machine-readable medium 722 is non-transitory in that it does not embody a propagating signal. However, labeling the tangible machine-readable medium 722 as “non-transitory” should not be construed to mean that the medium is incapable of movement—the medium should be considered as being transportable from one physical location to another. Additionally, since the machine-readable medium 722 is tangible, the medium may be considered to be a machine-readable device.

The instructions 724 may further be transmitted or received over a communications network 726 using a transmission medium via the network interface device 720 and utilizing any one of a number of well-known transfer protocols (e.g., HTTP). Examples of communication networks include a local area network (LAN), a wide area network (WAN), the Internet, mobile telephone networks, plain old telephone service (POTS) networks, and wireless data networks (e.g., WiFi, LTE, and WiMAX networks). The term “transmission medium” shall be taken to include any intangible medium that is capable of storing, encoding, or carrying instructions for execution by the machine, and includes digital or analog communications signals or other intangible medium to facilitate communication of such software.

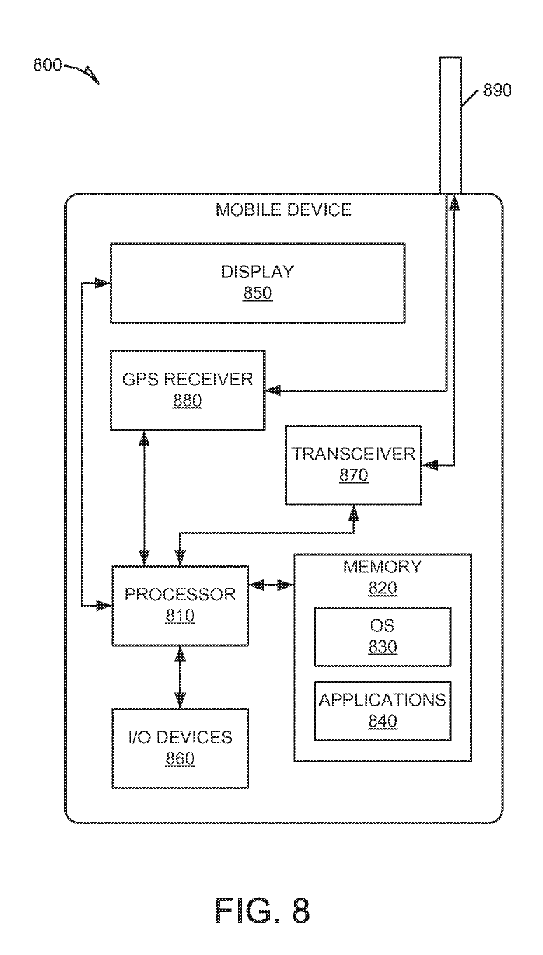

FIG. 8 is a block diagram illustrating a mobile device 800, according to an example embodiment. The mobile device 800 includes a processor 810. The processor 810 may be any of a variety of different types of commercially available processors suitable for mobile devices (e.g., an XScale architecture microprocessor, a Microprocessor without Interlocked Pipeline Stages (MIPS) architecture processor, or another type of processor). A memory 820, such as a Random Access Memory (RAM), a Flash memory, or other type of memory, is typically accessible to the processor. The memory 820 may be adapted to store an operating system (OS) 830, as well as application programs 840, such as a mobile location enabled application that may provide LBSs to a user. The processor 810 may be coupled, either directly or via appropriate intermediary hardware, to a display 850 and to one or more input/output (I/O) devices 860, such as a keypad, a touch panel sensor, a microphone, and the like. Similarly, in some embodiments, the processor 810 may be coupled to a transceiver 870 that interfaces with an antenna 890. The transceiver 870 may be configured to both transmit and receive cellular network signals, wireless data signals, or other types of signals via the antenna 890, depending on the nature of the mobile device 800. Further, in some configurations, a GPS receiver 880 may also make use of the antenna 890 to receive GPS signals.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

The reader of skill in the art will appreciate that claimed embodiments of the present invention are intended to provide one or more technical solution(s) to a technical problem unique to modern packet telecommunication systems, for at least solving the technical problems relating to call connections and maintenance of a call on a mobile packet telecommunication system. As discussed above, the claimed embodiments are substantially different from current routine steps and results when using conventional networks or computing elements because the present disclosure describes, for example, determining, using a connection application of a first user device, where the first user device is a call manager, and the call manager is responsible for reinitiating the call in response to the call being dropped and then activating, at the first user device, a call maintenance option provided by the connection application to automatically reinitiate the call by the call manager in response to the detecting that the call is dropped. For example, activating a call maintenance option at a user device, as described, indeed improves networked communications between devices of existing systems, advances techniques in call connection maintenance between devices, and reduces reliance on network computing resources to maintain the networked communication. Thus, as clearly technical solutions to patently technical problems, the claimed embodiments cannot be misunderstood as intended to foreclose unclaimed ways of solving these or other problems.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
initiating, at a first user device, a call to a second user device, each of the first user device and the second user device including a connection application for maintaining communications;
activating, at the first user device, a call maintenance option provided by the connection application;
determining, using the connection application of the first user device, that the first user device is a call manager, the call manager being responsible for reinitiating the call in response to the call being dropped;
detecting, by a hardware processor, whether the call is dropped; and
in response to the detecting that the call is dropped, reinitiating the call by the call manager.

2. The method of claim 1, further comprising:
periodically detecting and comparing parameters of the first user device and the second user device.

3. The method of claim 2, wherein the periodically detecting and comparing occurs at one of a predetermined time interval or an occurrence of an event.

4. The method of claim 1, wherein the determining that the first user device is the call manager comprises receiving a notification from a network service provider that the first user device is the call manager, the network service provider performing a process to determine that the first user device is the call manager by comparing parameter data for the first user device and the second user device to determine which of the first user device or the second user device has a higher parameter score.

5. The method of claim 1, wherein the determining that the first user device is the call manager comprises dynamically and periodically conducting a negotiation process between the first user device and the second user device, the negotiation process comprising: exchanging parameter data between the first user device and the second user device; and
comparing the parameter data to determine which of the first user device or the second user device has better parameters.

6. The method of claim 1, wherein the detecting whether the call is dropped comprises:
detecting that the call has ended; and
detecting that an end of call signal has not been received to end the call.

7. The method of claim 1, wherein the detecting whether the call is dropped comprises receiving a notification that the call has been dropped.

8. The method of claim 1, further comprising:
dynamically determining that the second user device is the call manager; and in response to the detecting that the call is dropped, placing the first user device in a standby mode, wherein the reinitiating the call by the call manager is performed by the second user device.

9. A system comprising:
one or more hardware processors;
a dialer module to initiate, at a first user device, a call to a second user device, each of the first user device and the second user device including a connection application for maintaining communications; and
the connection application, at the first user device, to activate and manage a call maintenance option, the connection application comprising:
a call management module to determine that the first user device is a call manager, the call manager being responsible for reinitiating the call in response to the call being dropped, and
a drop detection module, comprising at least one of the one or more hardware processors and configured to detect whether the call is dropped,
the call management module to, in response to detection that the call is dropped, trigger reinitiation of the call to the second user device.

10. The system of claim 9, further comprising a parameter module to:
periodically detect, at the first user device, parameters for the first user device; and
periodically receive parameters for the second user device.

11. The system of claim 9, wherein the call management module is further to compare the detected parameters for the first user device and the receiver parameters for the second user device to determine which of the first user device or the second user device has a higher parameter score.

12. The system of claim 11, wherein the higher parameter score is weighted according to preferences associated with at least one of the first user device or second user device.

13. The system of claim 9, wherein the call management module determines that the first user device is the call manager by dynamically and periodically conducting a negotiation process between the first user device and the second user device, the negotiation process comprising:
exchanging parameter data between the first user device and the second user device; and
comparing the parameter data to determine which of the first user device or the second user device has a higher weighted manager rating in that instance.

14. The system of claim 9, wherein the drop detection module detects whether the call is dropped by performing operations comprising:
detecting that the call has ended; and
detecting that an end of call signal has not been received to end the call.

15. The system of claim 9, further comprising a communication module to receive a notification that the call has been dropper, wherein the drop detection module detects that the call is dropped based on the notification.

16. The system of claim 9, wherein the call management module is to further dynamically determine that the second user device is the call manager, and in response to a detection that the call is dropped, place the first user device in a standby mode, wherein the reinitiation of the call is performed by the second user device.

17. A system comprising:
means for receiving a call request from a first user device to a second user device, each of the first user device and the second user device including a connection application for maintaining communications, the call request including an indication of an activation of a call maintenance option provided by the connection application;
means for establishing a call between the first user device and the second user device;
means for designating one of the first user device or the second user device as a call manager in response to the indication of the activation of the call maintenance option, the call manager being responsible for reinitiating the call in response to the call being dropped;
means for monitoring to detect whether the call is dropped; and
means for receiving a call reinitiation request from the call manager.

18. The system of claim 17, further comprising:
means for receiving parameter data for each of the first user device and the second user device;
means for exchanging the parameter data between the first user device and the second user device, the means for exchanging comprising data transmission means; and
means for maintaining the parameter data for each of the first user device and the second user device.

19. The system of claim 18 wherein the means for receiving the parameter data comprises one or more sensors configured to detect or obtain the parameter data for each of the first user device and the second user device.

20. The system of claim 17, wherein the means for designating one of the first user device or the second user device as the call manager determines the call manager based on which of the first user device of the second user device has better parameters.

21. The system of claim 17, wherein the means for monitoring detects the call is dropped by performing operations comprising:
detecting that the call has ended; and
detecting that an end of call signal has not been received to end the call.

22. A mobile communication user device capable of automated dropped call reinitiation, comprising:
a call initiation module operating at a user device, the user device including a connection application for maintaining communications, operable to initiate a call to a second user device;
a user selectable automated call maintenance option provided by the connection application and that determines, using the connection application of the user device, that the user device is a call manager, the call manager being responsible for reinitiating the call in response to the call being dropped; and
one or more processors operable to, at least:
detect whether the call is dropped,
determine whether the user device has been designated the call manager, and
in response to detecting that the call is dropped and that the user device is currently designated call manager, automatically reinitiate the call.
